(19) United States
(12) Patent Application Publication
(10) Pub. No.: US 2017/0303510 A1
(43) Pub. Date: Oct. 26, 2017

(54) Pet Toy with Adjustable Treat Dispensing Features

(71) Applicant: The KONG Company, LLC, Golden, CO (US)

(72) Inventors: John James Stone, Golden, CO (US); Chuck Costello, Louisville, CO (US)

(73) Assignee: The KONG Company, LLC, Golden, CO (US)

(21) Appl. No.: 15/135,315

(22) Filed: Apr. 21, 2016

(51) Int. Cl. A01K 15/02; A01K 5/00

(52) U.S. Cl. CPC A01K 15/026; A01K 5/00

(57) ABSTRACT

A treat dispensing device has a body and a hollow interior. A plurality of dispensing openings function to dispense treats. A non-adjustable opening is formed on an exterior surface of the body. A sleeve is slideably engaged within a part of the hollow interior of the body. At least one adjustable opening is formed on the sleeve. A user selectively places the pet toy in a first position to cover the adjustable opening with a portion of the body and a second position to expose the adjustable opening. The sleeve may include two sections in which an adjustable opening is formed on each section. A third position of the pet toy is defined by placement of the body relative to the sleeve so an adjustable opening is exposed on each sleeve section. An incremental position is defined by placement of the body relative to the sleeve so at least one adjustable opening is partially or fully exposed. A method includes placement of the device in a selected position to dispense treats at a selected rate for selected treats.

### FIELD OF THE INVENTION

The invention relates to pet toys that have the capability to dispense food or treats, and more particularly, to a treat dispensing device and method in which an adjustable feature of the device can selectively limit or increase rates at which treats are dispensed.

### BACKGROUND OF THE INVENTION

Interactive pet toys have become more popular in recent times. Interactive pet toys can be defined as those that encourage an animal to interact with the toy because of some type of stimulus associated with the toy. The stimulus can take many forms, such as food/treats, smell, sound, the shape or resiliency of the toy, and others. Animal behaviorists confirm that many therapeutic benefits are provided to a pet by an interactive pet toy. For example, chew toys with treats provide both mastication and extended overall physical preoccupation of the animal. Toys with edible treats are known to help remediate separation anxiety in some pets in which an animal may be less prone to engage in negative behavior since the animal is occupied over a longer period of time, and at greater occupation intensity.

There are a significant number of U.S. patent references that disclose treat dispensing pet toys or pet toys with frictionally held treats. One example of a reference disclosing a pet toy with treats includes U.S. Pat. No. 7,555,997. This reference describes an exterior feature for holding treats by a peripheral lip that surrounds and overlaps a corresponding peripheral edge of a first treat, and an interior open space that may be used to hold additional treats. The first treat blocks access to the interior open space.

Another reference disclosing a pet toy with treats is the U.S. Pat. No. 7,500,450. This reference teaches a toy with a hollow interior, a first edible treat that blocks access to the interior, and a second edible treat that interlocks with the first edible treat, the second edible treat extending into the interior of the toy. Additional treats may be placed within the hollow interior.

Yet another reference disclosing pet toys with treats is the U.S. Pat. No. 6,470,830. This reference describes a toy with a trapper cavity or slot to receive a treat. An adjacent biased cavity forms a biasing member between the trapper cavity and slot. Opposing walls of the trapper cavity clamp against surfaces of the treat inserted through the cavity.

Yet another reference in the field of pet toys with integral treats is the U.S. Pat. No. 5,832,877. This reference discloses a pet toy with a longitudinal panel, and first and second lips formed along opposite respective edges of the panel. The edges are folded over to form overlapping areas that serve as receptacles to receive treats.

Yet another reference that discloses a pet toy incorporating treats is the U.S. Pat. No. 6,129,053. This reference teaches a pet toy having an outer surface with one or more recesses for holding treats. The recesses may be of varying depths and shapes to receive different types of treats. Some of the recesses may extend completely through the sidewall of the toy.

One example of an animal food dispenser includes the invention disclosed in U.S. Pat. No. 6,526,912. This reference more specifically discloses a dispenser having a base portion and an upper portion defined by at least one wall enclosing a container cavity. An opening is formed in the upper portion to access the container cavity. A weighted body is fixed to the base of the dispenser, and provides a means for returning the dispenser to an upright position after the dispenser has been tipped or moved by the animal. The dispenser can be moved on a surface in an oscillating and/or sliding motion by the animal for dispensing a unit from the opening.

Despite the number of references disclosing such pet toys, there is still a need to provide a treat dispensing device for pets that can occupy an animal over a longer period of time. There is also an unmet need to provide a device that is capable of dispensing multiple different types of treats and at different dispensing rates within the same toy. An unmet need also exists for a device that can extend and intensify an animal's interaction with the pet toy based on behavior of the animal as the animal interacts with the toy. Finally, there is a continuing need to provide the aforementioned attributes in a pet toy that maintains a structurally simple yet reliable construction.

### SUMMARY OF THE INVENTION

According to the invention, a treat or food dispensing device and method are provided that allows treats/food to be dispensed at selected different rates and amounts as controlled by an adjustable treat dispensing feature of the device. The word “treat” hereinafter is meant to include all animal foodstuffs that can be consumed by an animal. Treats make take various forms such as uniformly sized nuggets, or the treats may be irregularly sized and shaped. Further, the treats may be of a predetermined size or shape to fit through only a first type of opening of the pet toy. A second type of treat may have a different predetermined size or shape to fit through only a second type of opening of the pet toy.

According to the device of the invention, a treat dispensing device has a body of a desired shape and a plurality of treat dispensing openings or holes. Generally, the size and shape of the treat dispensing openings can be selected to dispense treats also having different sizes and shapes. Accordingly, each of the treat dispensing openings can be conceptually viewed as separate and distinct treat dispensing elements or units incorporated within a single pet toy.

Additionally, there are two types of treat dispensing openings. A first type is openings that are static or not adjustable and therefore maintain a fixed shape and size. The second is dynamic or adjustable openings that may be controlled to take on a desired shape or size as selected or adjusted by a user of the device. The dynamic or adjustable openings are selectively controlled by placing the device in a desired position. In a first closed position, the adjustable openings are closed or sealed such that no treats may be dispensed therethrough. In a second partially open position, one or more adjustable openings are exposed so that treats may be dispensed through at least one of the adjustable openings. In a third fully open position, additional adjustable openings are exposed so that additional treats may be dispensed and/or treats may be dispensed at a higher rate. For the second partially open position, this particular position may include an infinite number of slight positional variations in which the user can adjust or control the position of the pet toy such that one or more openings are selectively exposed a desired amount for enabling a selective treat dispensing function.

In a preferred embodiment of the invention, it includes at least one non-adjustable opening and two adjustable openings in which one of the adjustable openings is exposed when the device is in the second partially open position and the other adjustable opening is exposed when the device is in the third fully open position.

The structure of the pet toy may be further described as including a body with an exterior surface and an interior surface defining a chamber to hold treats. The body may comprise a first body portion slidably interconnected to a second body portion by a sleeve. The sleeve may be frictionally engaged by interior surfaces of the first and second body portions. In one embodiment, the non-adjustable openings are formed on at least one of the first and second body portions. The adjustable openings are formed on the sleeve. Accordingly, as the first and second body portions are moved together, one or more of the adjustable openings may be at least partially obstructed by the first or second body portion. Optionally, the first and second body portions may be pulled completely apart from each other. In another embodiment, the pet toy includes a stop to prevent complete separation of the first and second body portions.

The exterior surface of the pet toy body may include features to enhance interaction with the animal and to provide the pet toy in a shape or size that is interesting or pleasing to the user. For example, in one preferred embodiment, the pet toy may resemble a stick or twig with bumps or ridges and surface irregularities which resemble the exterior surface of the twig. In another preferred embodiment, the pet toy may resemble a fire hydrant with exterior surface features which resemble the fire hydrant. In another preferred embodiment, the pet toy may resemble the paw of an animal which also has exterior features that resemble the paw.

The material used for the pet toy may be elastomeric, semi-rigid, or rigid. For some animals, it may be advantageous for the pet toy to be flexible and elastomeric, thereby encouraging the animal to chew on the toy. For other animals, it may be advantageous for the pet toy to be more rigid so that dispensing treats is primarily achieved by movement and rotation of the pet toy to cause treats to pass through the treat dispensing openings.

The pet toy of the invention has a number of purposes. One purpose is for the pet toy to serve as a treat dispenser for dispensing treats associated with a normal meal of the animal. Accordingly, the invention in this purpose serves to slow down the feeding activity of the animal. Another purpose of the pet toy is to serve as a more natural feeding and foraging experience for the animal in which consumption is achieved over a greater period of time with significantly greater effort than simply feeding the animal from a traditional bowl. Another purpose of the pet toy is to encourage exercise and activity of the animal that is not naturally associated with a scheduled feeding of the animal.

It is another aspect of the invention to provide projections proximate to each treat dispensing opening of the pet toy. The projections may be formed or affixed to an interior surface of the pet toy and extend generally perpendicularly into the pet toy. The projections may be arranged to alter a rate at which treats are dispensed from each opening. Additionally, the projections increase the effective depth of each opening. The projections may also reduce or eliminate the possibility of a paw pad of an animal becoming trapped in the opening.

According to another aspect of the invention, a method is provided for dispensing treats. The method is achieved with a dispensing device having a number of variables to enhance the number of options for providing treats. One variable is the size of the treat openings in the device. Another variable is the number of treat openings in the device. Another variable is the shaped of the treat openings in the device. One can appreciate from the multiple foregoing variables that the method of invention can be specifically tailored to dispense the number and type of treats over a desired period of time. The method can also be tailored to dispense treats with a desired amount of effort from the animal.

In one aspect of the invention, it may be considered a pet toy with adjustable treat dispensing features comprising: (i) a body defining a shape of the pet toy, and a hollow interior space within said body; (ii) a plurality of dispensing openings incorporated in said body for dispensing treats, said dispensing openings including at least one nonadjustable opening formed on an exterior surface of said body; (iii) a first sleeve inserted within a first part of said body and making frictional engagement with an interior surface of said first part, said dispensing openings further including at least one first adjustable opening formed on said sleeve; and wherein a user may selectively place the pet toy in a first position to cover said at least one adjustable opening and a second position to expose said at least one adjustable opening.

In another aspect of the invention, it may be considered in combination, a pet toy with adjustable treat dispensing features and treats loaded within the pet toy, comprising: (i) a body defining a shape of the pet toy, and a hollow interior space within said body; (ii) a plurality of dispensing openings incorporated in said body for dispensing treats, said dispensing openings including at least one nonadjustable opening formed through an exterior surface of said body; (iii) a first sleeve inserted within a first part of said body and making frictional engagement with an interior surface of said first part, said dispensing openings further including at least one first adjustable opening formed through said sleeve; (iv) a plurality of treats loaded in said pet toy, and dispensed by movement of the pet toy to cause at least some of said treats to pass through said dispensing openings; and wherein a user may selectively place the pet toy in a first position to cover said at least one adjustable opening and a second position to expose said at least one adjustable opening.

In yet another aspect of the invention, it may be considered a method of dispensing treats from a pet toy, comprising: (a) providing a pet toy comprising (i) a body defining a shape of the pet toy, and a hollow interior space within said body; (ii) a plurality of dispensing openings incorporated in said body for dispensing treats, said dispensing openings including at least one nonadjustable opening formed on an exterior surface of said body, and (iii) a first sleeve inserted within a first part of said body and making frictional engagement with an interior surface of said first part, said plurality of dispensing openings further including at least one first adjustable opening formed on said sleeve; (b) loading a plurality of treats in the pet toy; and (c) moving the pet toy to cause at least some of said treats to pass through said dispensing openings.

Other features and advantages of the invention will become apparent from a review of the following detailed description, taken in conjunction with the drawings.

### BRIEF DESCRIPTION OF THE DRAWINGS

FIG. 1 is a front elevation view of a first preferred embodiment of the pet toy invention showing the pet toy in a first closed position;

FIG. 2 is a rear elevation view of the pet toy of FIG. 1 of the first preferred embodiment;

FIG. 3 is a front elevation view of the pet toy of FIG. 1 in a second partially open position;

FIG. 4 is a front elevation view of the pet toy of FIG. 1 in a third fully open position;

FIG. 5 is a perspective view of the pet toy of FIG. 1 in the third fully open position;

FIG. 5A is an enlarged partial cut-away view of a portion of FIG. 5 showing projections formed at the treat openings to control the dispense rate and to prevent an animal's paw from becoming trapped inside the pet toy;

FIG. 6 is a front elevation view of a second preferred embodiment of the pet toy invention showing the pet toy in a first closed position;

FIG. 7 is a front elevation view of the pet toy of FIG. 6 in a second partially open position;

FIG. 8 is a front elevation view of the pet toy of FIG. 6 in a third fully open position;

FIG. 9 is a perspective view of the pet toy of FIG. 6 in the third fully open position;

FIG. 10 is a front elevation view of a third preferred embodiment of the pet toy invention showing the pet toy in a first closed position;

FIG. 11 is a front elevation view of the pet toy of FIG. 10 in a second partially open position;

FIG. 12 is a front elevation view of the pet toy of FIG. 10 in a third fully open position; and

FIG. 13 is a perspective view of the pet toy of FIG. 10 in the third fully open position.

### DETAILED DESCRIPTION

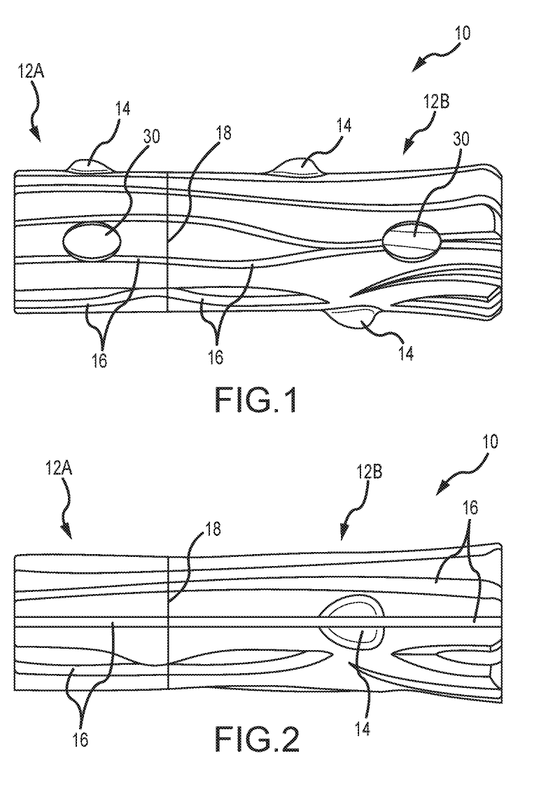

Referring to FIG. 1, the invention is shown in a first embodiment in which a pet toy 10 resembles a stick or twig. The pet toy 10 has an elongate body 12 with features on an exterior surface thereof which create the appearance of the stick or twig. These features include a plurality of bumps or ridges 14 and surface irregularities comprising grooves or channels 16 that extend in a random manner resembling bark.

Also referring to FIGS. 2-5, the body 12 is separable in two parts, 12A, 12B. Opposing faces of the two parts of the body 12A, 12B can be joined or separated from one or another along interfacing or abutting edges 18. More specifically, the individual body portions 12A, 12B can be pulled apart thereby lengthening the pet toy 10 or pushed together to shorten the body 12 of the pet toy 10 as shown.

A plurality of treat dispensing openings is formed on the exterior surface of the body 12. A first type of treat dispensing openings 30 may be selectively located on the exterior surface. The openings 30 are static or non-adjustable, meaning they do not change shape or size and are not obstructed by relative movement of the portions of the body 12A, 12B. A second type of treat dispensing openings 32 are provided and are selectively located on a sleeve 20 that is disposed within the body 12. These openings 32 are dynamic or adjustable, meaning that a user may selectively change the effective shape or size of these openings, to include closing off or sealing the openings 32, with at least one of the portions of the body 12A, 12B so that treats cannot be dispensed from them. The openings 30, 32 communicate with a hollow chamber 34 formed in the pet toy body 12.

The static openings 30 and the dynamic openings 32 may have any shape. Accordingly, although the openings 30, 32 are illustrated having a generally oval shape, the openings may have a shape that is circular, triangular, square, are a combination thereof. The dynamic openings 32 may have a shape or size that is the same as or different from, a shape or size of the static openings 30. For example, in one embodiment, the static openings 30 have a first shape and the dynamic openings 32 have a different second shape. In another embodiment, the static openings 30 have a first size and the dynamic openings 32 have a different second size. Additionally or alternatively, the static openings 30 may be adapted to dispense a first type of treat and the dynamic openings 32 may be adapted to dispense a different second type of treat. Accordingly, in one embodiment, the static openings 30 have a shape and size adapted to dispense the first type of treats and the dynamic openings 32 have a different shape and size adapted to dispense the second type of treats. Additionally or alternatively, one static opening 30 may have a different size or shape than a second static opening 30. Similarly, one dynamic opening 32 may have a different size or shape than a second static opening 32.

FIGS. 1 and 2 show the pet toy 10 in the first closed position in which the dynamic or adjustable openings 32 are closed or sealed by the body portion 12B such that no treats may be dispensed from them. As shown, the two parts of the body 12A, 12B are pushed against one another so that the opposing faces of the two parts contact one another along interface or abutting edges 18.

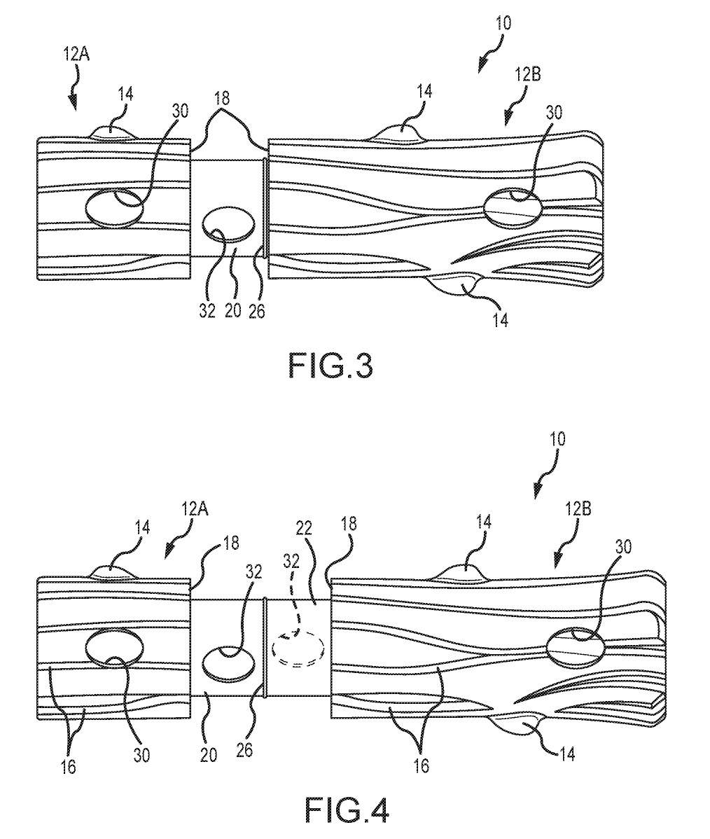

FIGS. 3 and 4 show the pet toy 10 in the second and third positions, respectively. According to the second partially open position shown in FIG. 3, the two body parts 12A, 12B are pulled apart thereby exposing a first portion of the interior sleeve 20 and an adjustable opening 32 formed on the first portion of the sleeve 20. In order to confirm that the pet toy 10 has been placed in the second position, the first portion of the sleeve 20 may have a small peripheral protrusion or flange 26 that engages a corresponding feature formed on the interior surface of the body 12B, such as another protrusion, or a recess or groove (not shown) such that when the protrusion 26 engages the corresponding feature, there is an audible “click” sound or a tactile feel. The engagement of the protrusion 26 with the corresponding feature of the body 12B may also serve to stabilize or maintain the pet toy 10 in this selected second position.

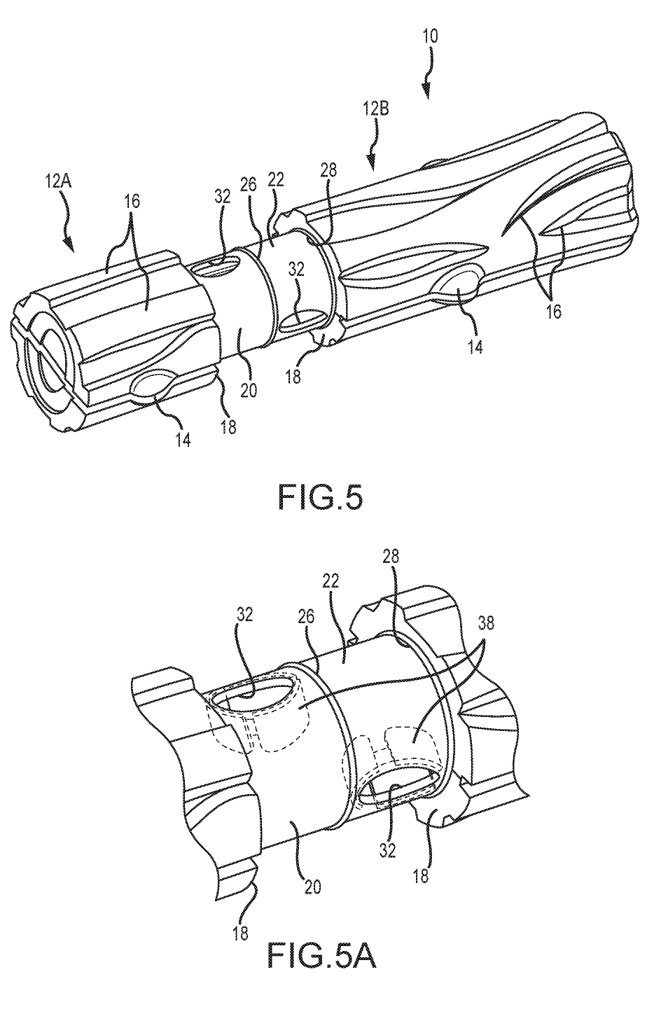

According to the third fully open position shown in FIGS. 4 and 5, the body parts 12A, 12B are further pulled apart thereby exposing a second portion of the interior sleeve 22 and another adjustable opening 32 formed on the second portion of the sleeve 22. As with the placement of the pet toy 10 in the second position, to confirm the pet toy has been placed in the third position, the second sleeve portion 22 may also have a small peripheral protrusion or flange 28 that engages a corresponding feature such as another protrusion, recess or groove (not shown) formed on the interior surface of the body 12B so the user may receive an audible “click” or tactile feel to confirm that the protrusion has engaged the corresponding feature. It will be appreciated that although only two flanges 26, 28 are illustrated on the sleeve portions 20, 22 any number of flanges may be formed associated with a plurality of different positions of the sleeve and the body.

The sleeve portions 20 and 22 may be slideable within one part of the body 12, or both parts. That is, the free end of either sleeve portion 20, 22 may be rigidly connected to the corresponding abutting edge of the body 12, and the opposite end of the sleeve is slideable within the other body part. Alternatively, both free ends of the sleeve portions 20, 22 may be slideable within their corresponding part of the body 12. In either instance, it should be appreciated that the pet toy 10 can be selectively placed in a desired dispensing position by simply pulling the two parts of the body 12A, 12B apart from one another a desired distance thereby exposing a desired number of adjustable openings 32. In one embodiment, the sleeve portions 20, 22 are slidably interconnected. In another embodiment, the sleeve portions 20, 22 comprise different portions of a single sleeve.

Preferably, the exterior surface of the sleeves 20 and 22 make adequate frictional contact with the interior surfaces of the body 12 so that the body parts may be pushed and pulled without undue force, yet the pet toy will remain the selected position. Slightly additional force is required to set the pet toy in the second or third positions, and the audible “click” sound confirms these positions as mentioned. Optionally, one or more detents (not shown) may be formed on the interior surface of the body 12B or the exterior surface of the sleeve portions 20, 22 to prevent inadvertent or unintended movement of the body 12B relative to the sleeve portions. The detents may be in addition to, or instead of, the flanges 26, 28. Alternatively, in one embodiment, the body portions 12A, 12B may include a lock (not shown) that is engaged by axial rotation relative to the sleeve portions 20, 22. Accordingly, rotating one of the body portions in a first axial direction relative to the other body portion will unlock the pet toy such that the body portions may be moved axially relative to each other. Rotating one of the body portions in a second axial direction relative to the other body will lock the pet toy preventing axial movement of the body portions.

In addition to the second and third positions, a user may also choose to selectively place the pet toy 10 in a number of other positions between the first and second positions, between the first and third positions, and/or between the second and third positions in which either or both of the sleeve portions 20 and 22 are at least partially exposed to therefore at least partially expose selected ones of the adjustable openings 32. In this way, a user is provided options for controlling the rates of treat dispensing.

Referring now to FIG. 5A, additional details of the interior of the pet toy 10 are illustrated. As shown, the pet toy 10 generally includes an internal chamber 34. An interior surface 36 of the chamber 34 may include projections 38. The projections may be positioned adjacent or proximate to the openings 32. The projections 38 may be arranged to control, or alter, the rate of dispense of treats through the openings 32. For example, relatively shorter projections 38 will provide less obstruction for treats passing through the openings 32, while relatively longer projections 38 provide more obstruction for treats passing through the dispensing openings 32. The projections 38 may be formed of individual projection elements. In one embodiment, gaps are arranged between each individual projection element. Alternatively, it will be appreciated that a single cylindrical projection may be positioned proximate to, and surrounding, each of the openings 32. In another embodiment, individual projections 38 of different lengths are positioned proximate to each of the openings 32 such that there are no gaps or space between the individual projections. The particular size, shape, and length of the projections 38 can be selected to optimize a particular dispense rate. Optionally, the projections 38 may be removably interconnected to the chamber interior surface 36. Accordingly, the projections 38 can be rearranged, or removed from, the pet toy 10. Alternatively, the projections may be integrally formed with the sleeve 20, 22. Although the projections 38 are illustrated associated with the adjustable opening 32, it will be appreciated that the projections may optionally be formed proximate to each opening 30, 32 of the pet toy 10.

The projections 38 also serve as a safety feature reducing the risk of an animal paw pad becoming lodged/trapped in the dispensing openings 30, 32. Without the projections, a paw pad could compress and slip into the dispensing openings 30, 32. For example, if an animal places its paw through the opening 30, 32, the paw may re-expand and become trapped. With use of the projections 38, the ability of the paw pad to re-expand after entering the dispensing opening 30, 32 is greatly reduced or eliminated since the projections 38 increase the effective depth of the opening 30, 32 and keeps the paw pad compressed, thereby allowing the pad to slide back out of the dispensing hole. In the event the animal does pass the paw pad completely through the dispensing opening 30, 32 and beyond the projections 38, the gaps between the projections 38 allows the animal's individual pads on the paw to naturally compress or be drawn toward one another causing the paw pad as a whole to return to a smaller compressed size so it can be withdrawn back through the dispensing opening 30, 32.

After the pet toy 10 is in the third position, if the user pulls the body parts 12A, 12B further apart, the body part 12A may be completely separated from body part 12B. In this manner, an open end of each body part 12A, 12B may be revealed. The user may then load treats into the pet toy chamber 34 through the open ends. Alternatively, the user may load treats into the chamber 34 through the openings 30, 32 without completely pulling apart the two parts of the body 12A, 12B.

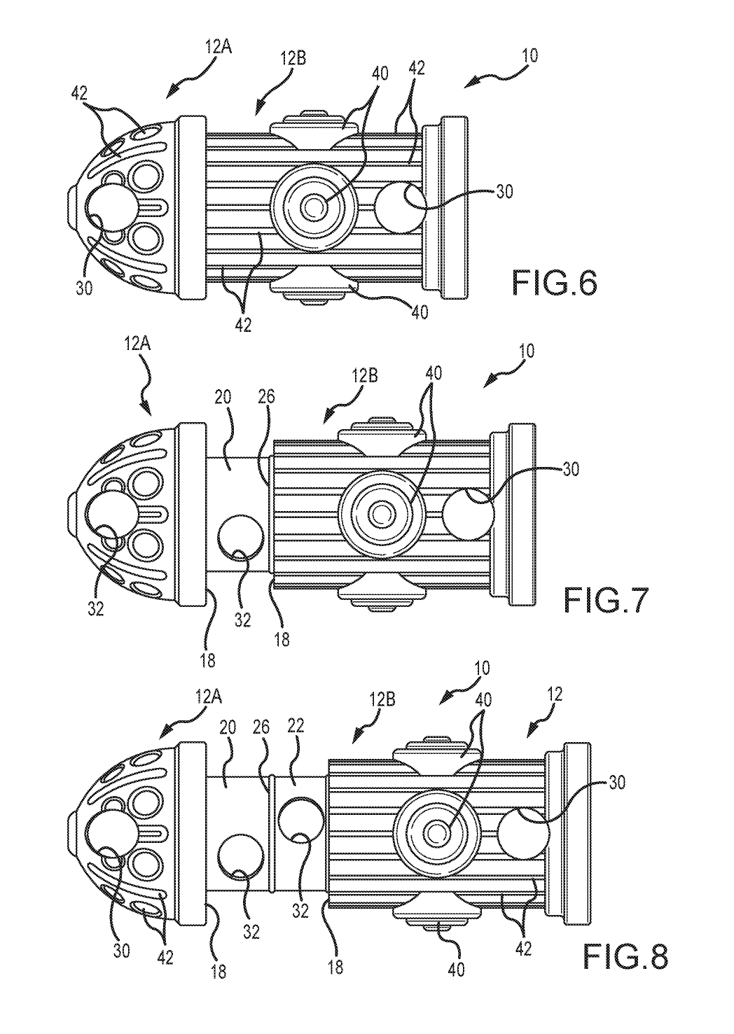

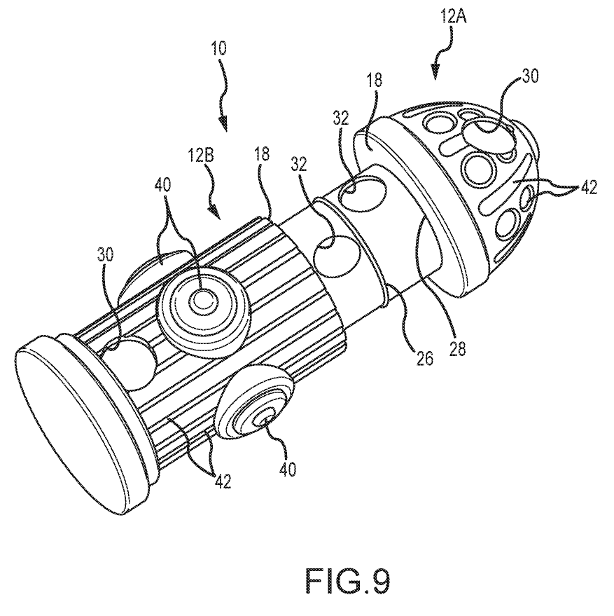

Referring to FIGS. 6-9, another preferred embodiment is illustrated in which the pet toy 10 resembles the shape of a fire hydrant. Like reference numerals used in these figures correspond to the same structural elements described for the first embodiment of the pet toy 10 illustrated in FIGS. 1-5. The exterior surface of the pet toy 10 in this second embodiment has other features which cause the pet toy 10 to resemble a fire hydrant. Specifically, the pet toy 10 includes ornamentation 40 and various surface irregularities 42 which in combination, along with the shape of the pet toy, provide the features that resemble a fire hydrant.

The pet toy in the second embodiment functions in the same way as the first embodiment: a user may pull apart the two body parts 12A, 12B in order to selectively expose a desired number of adjustable treat openings 32 according to the second and third positions. The two body parts 12A, 12B may also be pushed together in order to at least partially close or seal off the adjustable treat openings 32 according to the first position. The user may also selectively place the pet toy 10 between the first and third positions, between the first and second positions, or between the second and third positions to incrementally adjust a desired rate of treat dispensing.

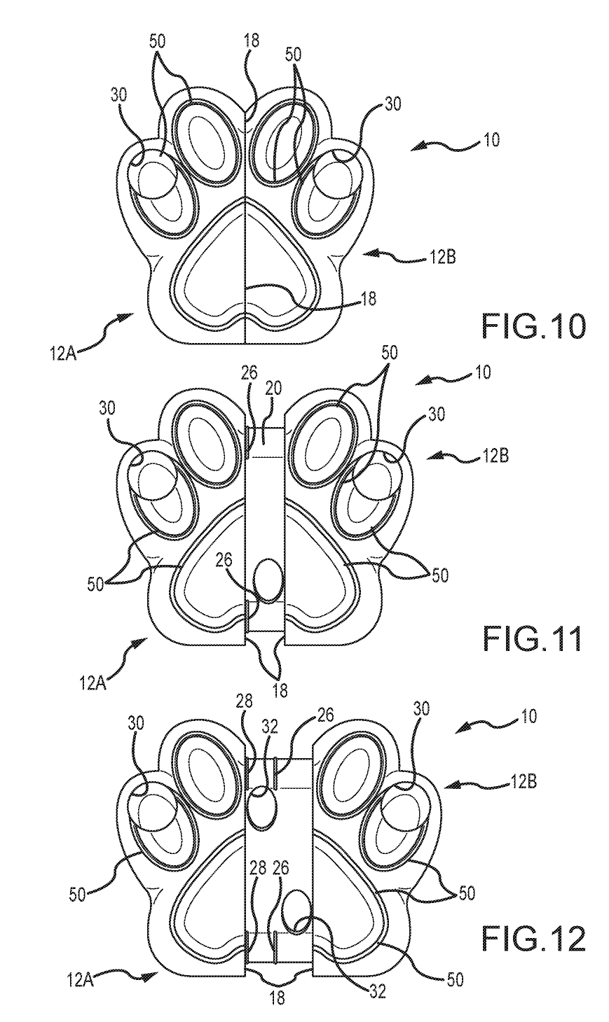

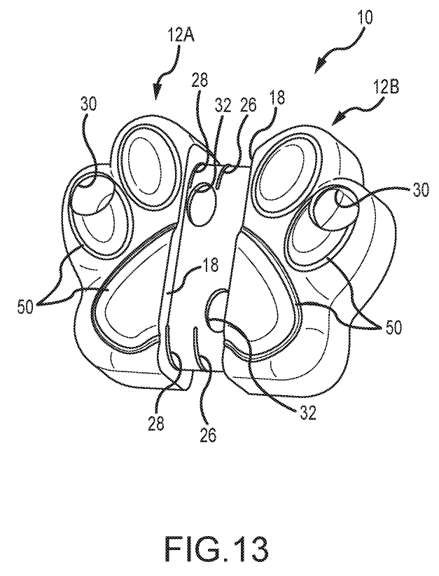

Referring to FIGS. 10-13, a third preferred embodiment is illustrated in which the pet toy 10 resembles the shape of an animal paw. Again, like reference numerals used in these FIGS. 10-13 correspond to the same structural elements described for the first embodiment of the pet toy illustrated in FIGS. 1-5. The exterior surface of the pet toy 10 in this third embodiment has other features which cause the pet toy to resemble an animal paw. Specifically, the pet toy 10 includes various surface irregularities 50 which in combination, along with the shape of the pet toy, provide the features that resemble an animal paw.

The pet toy 10 in the third embodiment functions in the same way as the first and second embodiments. Again, a user may pull apart the two body parts 12A, 12B of the pet toy 10 in order to selectively expose a desired number of adjustable treat openings 32 according to the second and third positions illustrated in FIGS. 11 and 12, respectfully. The two body parts 12A, 12B may also be pushed together in order to close or seal off the adjustable treat openings 32 according to the first position as illustrated in FIG. 10. The user may also selectively place the pet toy 10 between any of the first, second, and third positions to incrementally adjust a desired rate of treat dispensing. For example, the user may separate the body parts 12A, 12B to an intermediate position between the first and second positions illustrated in FIGS. 10 and 11 or to different intermediate positions between the second and third positions illustrated in FIGS. 11 and 12.

The projections 38 may be selectively incorporated in any or all of the embodiments of the invention. Therefore, while projections are only illustrated in the embodiment of FIG. 5A, it shall be understood that projections can be added to any of the other embodiments, to include projections added to selected openings 30 and 32 for each embodiment.

According to a method of the invention, a pet toy 10 is provided with a plurality of openings 30, 32 dispersed at various locations on a body 12 of the pet toy. One or more of the openings 30 may be static or nonadjustable, while one or more other openings 32 may be dynamic or adjustable. A user charges or loads a chamber 34 of the pet toy 10 with treats by completely pulling apart the two parts of the body 12A, 12B and inserting treats in the open ends, or pulls apart the two parts 12A, 12B to expose one or more of the adjustable openings 32 and inserts the treats through the adjustable openings 32. The user determines a desired dispense rate and then adjusts the pet toy 10 body 12A, 12B in the first, second, or third positions, or in a desired incremental position between the second and third positions or between the first and second positions. The pet toy 10 is given to an animal and the animal interacts with the pet toy causing it to be moved or rotated and the pet toy subsequently dispenses treats through one or more of the openings 30, 32.

There are number of advantages to the invention. The pet toy 10 includes a plurality of distinct dispensing capabilities that provide a pet owner with multiple options for dispensing treats. The pet toy may be used as a feeder for meals, a dispenser for snacks, or a combination of both. Because multiple dispensing openings 30, 32 are provided, the pet toy 10 may be used as both a feeder and snack dispenser, simultaneously. The different sizes of dispensing openings 30, 32 that can be created based on selected positions, as well as the number of openings in the device, provide different levels of difficulty for treat extraction and different rates of treat dispensing.

Although the invention is described in more specific detail with reference to one or more preferred embodiments, it shall be understood that the invention can be changed or modified commensurate with the scope of the claims appended hereto and therefore, the preferred embodiments should not be construed as specifically limiting or otherwise constraining the scope of the invention.

What is claimed is:

1. A treat dispensing pet toy, comprising:
a body defining a shape of the pet toy, and a hollow interior space within said body;
a plurality of dispensing openings incorporated in said body for dispensing treats, said dispensing openings including at least one nonadjustable opening formed on an exterior surface of said body;
a first sleeve portion inserted at least partially within said hollow interior space of said body and making frictional engagement with an interior surface of said hollow interior space, at least one first adjustable opening of said plurality of dispensing openings formed on said first sleeve portion; and
wherein a user may selectively place the pet toy in a first position to cover said at least one first adjustable opening and a second position to expose said at least one first adjustable opening.

2. A treat dispensing pet toy, as claimed in claim 1, further including:
a second sleeve portion connected to said first sleeve portion and making frictional engagement with said interior surface of said body, at least one second adjustable opening formed on said second sleeve portion; and
wherein the user may selectively place the pet toy in the first position to cover said at least one first and second adjustable openings, the second position to expose said at least one first adjustable opening, and a third position to expose each of said at least one first and second adjustable openings.

3. A treat dispensing pet toy, as claimed in claim 2, wherein:
said first and second sleeve portions are connected to one another forming a single larger consolidated sleeve assembly.

4. A treat dispensing pet toy, as claimed in claim 1, wherein:
said dispensing openings have different sizes.

5. A treat dispensing pet toy, as claimed in claim 1, wherein:
said treat dispensing openings have different shapes.

6. A treat dispensing pet toy, as claimed in claim 1, further including:
a peripheral protrusion formed on said first sleeve portion that selectively engages a corresponding feature formed on an interior surface of said body to confirm a selected position.

7. A treat dispensing pet toy, as claimed in claim 6, wherein:
engagement of said peripheral protrusion with said corresponding feature results in an audible sound perceptible by the user to confirm the selected position.

8. A treat dispensing pet toy, as claimed in claim 1, wherein:
at least one projection extending from an interior surface of the pet toy adjacent to each of said dispensing openings.

9. In combination, a treat dispensing pet toy and treats loaded within the pet toy, comprising:
a body defining a shape of the pet toy, and a hollow interior space within said body;
a plurality of dispensing openings incorporated in said body for dispensing treats, said dispensing openings including at least one nonadjustable opening formed through an exterior surface of said body;
a first sleeve portion inserted within said body and making frictional engagement with an interior surface of said body, said dispensing openings including at least one first adjustable opening formed through said first sleeve portion;
a plurality of treats loaded in said interior space of said pet toy, said treats dispensed by movement of the pet toy to cause at least some of said treats to pass through said dispensing openings; and
wherein a user may selectively place the pet toy in a first position to at least partially cover said at least one first adjustable opening and a second position to at least partially expose said at least one first adjustable opening.

10. The combination, as claimed in claim 9, further including:
a second sleeve portion inserted within said body, said second sleeve portion making frictional engagement with the interior surface of said body, said dispensing openings including at least one second adjustable opening formed on said second sleeve portion; and
wherein the user may selectively place the pet toy in the first position to at least partially cover said at least one first adjustable opening and to completely cover said at least one second adjustable opening, the second position to at least partially expose said at least one first adjustable opening with said at least one second adjustable opening completely covered, and a third position to completely expose said at least one first adjustable opening and to at least partially expose said at least one second adjustable opening.

11. The combination, as claimed in claim 10, wherein:
said first and second sleeve portions are connected to form a single larger sleeve assembly.

12. The combination, as claimed in claim 9, further including:
a peripheral protrusion formed on said first sleeve portion that selectively engages a corresponding feature formed on an interior surface of said body to confirm a selected position of said first sleeve portion within said body.

13. The combination, as claimed in claim 12, wherein:
engagement of said peripheral protrusion with said corresponding feature results in an audible sound perceptible by the user to confirm the selected position.

14. The combination, as claimed in claim 9, further comprising:
at least one first projection extending from an interior surface of said body and adjacent to said at least one nonadjustable opening.

15. The combination, as claimed in claim 14, further comprising:
at least one second projection extending from an interior surface of said first sleeve portion and adjacent to said at least one first adjustable opening.

16. A method of dispensing treats from a pet toy, comprising:
providing a pet toy comprising:
(i) a body defining a shape of the pet toy, and a hollow interior space within said body;
(ii) a plurality of dispensing openings incorporated in said body for dispensing treats from said hollow interior space, said dispensing openings including at least one nonadjustable opening formed in an exterior surface of said body; and
(iii) a first sleeve portion inserted within a portion of said body and making frictional engagement with an interior surface of said body, said dispensing openings further including at least one first adjustable opening formed on said first sleeve portion;
loading a plurality of treats in said hollow interior space of said body of the pet toy; and
moving the pet toy to cause at least some of said treats to pass through said dispensing openings.

17. The method, as claimed in claim 16, further including:
placing the pet toy in a second partially open position by pulling a first part of said body away from a second part of said body thereby at least partially exposing said at least one first adjustable opening.

18. The method, as claimed in claim 17, further including:
placing the pet toy in a third fully open position by further pulling the second part of said body away from the first part of said body thereby completely exposing said at least one first adjustable opening and at least partially exposing at least one additional adjustable opening.

19. The method, as claimed in claim 18, further including:
placing the pet toy in a first position by moving the first part of said body to abut the second part of said body thereby covering said at least one first adjustable opening and said at least one additional adjustable opening by the second part of said body.

20. The method, as claimed in claim 19, wherein:
wherein treats are dispensed at different rates in the first position as compared to when the pet toy is placed in the second and third positions.

21. The method, as claimed in claim 19, further including:
placing the pet toy in an incremental position between said second and third positions by pulling at least one of the first or second parts of said body thereby fully exposing or partially exposing said at least one first adjustable opening or said at least one additional adjustable opening.

22. The method, as claimed in claim 16, said pet toy further comprising:
projections affixed to the pet toy proximate to each of the plurality of dispensing openings, said projections extending generally radially inwardly into said hollow interior space of the pet toy.

23. The method, as claimed in claim 16, wherein loading the plurality of treats comprises:
pulling a first part of said body away from a second part of said body thereby exposing an aperture at a first axial end of the first part and a second axial end of the second part; and
loading treats into the hollow interior space of said body through at least one of said first and second axial ends.

24. The method, as claimed in claim 16, wherein loading the plurality of treats comprising:
loading a first type of said treats in said hollow interior space, said first type of treats adapted to fit through only said at least one nonadjustable opening; and
loading a second type of said treats in said hollow interior space, said second type of treats adapted to fit through only said at least one first adjustable opening.
